(19) United States
(12) Patent Application Publication
(10) Pub. No.: US 2014/0274289 A1
(43) Pub. Date: Sep. 18, 2014

(54) PAYLINES IN THREE DIMENSIONS

(71) Applicants: Russell Brooke Dunn, Henderson, NV (US); Evan Arthur Ratcliff, Sherman Oaks, CA (US); Michele Gibilisco, Longwood, FL (US)

(72) Inventors: Russell Brooke Dunn, Henderson, NV (US); Evan Arthur Ratcliff, Sherman Oaks, CA (US); Michele Gibilisco, Longwood, FL (US)

(21) Appl. No.: 13/843,531

(22) Filed: Mar. 15, 2013

(51) Int. Cl. G07F 17/34

(52) U.S. Cl. CPC G07F 17/34
USPC 463/20

(57) ABSTRACT

A gaming apparatus comprising a processor, game logic, a video display and player input system configured to execute a method comprising:
a) the processor accepting a first wager on a game which is determined by at least displayed random symbol outcomes in a payline;
b) the processor providing the first random event outcome of at least three individual die outcomes;
c) the processor displaying an image on the video display that includes a virtual image of the displayed random symbol outcomes in a display format that contains symbol display frames in apparent three-dimensions;
d) the processor determining whether paylines in apparent three dimensions include virtual symbols forming i) a winning outcome or ii) a non-winning outcome; and
e) the processor resolving the first wager by awarding value monitored by the gaming system when i) occurs and withdrawing value monitored by the gaming system when ii) occurs.

### BACKGROUND OF THE INVENTION

1. Field of the Invention

The present invention relates to the field of electronic wagering devices in which wagers on individual paylines are resolved on outcomes of symbol distributions or alignments within the paylines. The present technology provides new orientations of the paylines.

2. Background of the Art

In video gaming systems, game events and outcomes are determined by symbols that are distributed within positions, frames or spatial orientation. After symbols are distributed, the distribution, location, orientation and/or presence of specific symbols is used to determine winning, losing or tie events.

The original distribution of symbols was on reels or wheels. Winning events were determined by the presence of predetermined winning orientations in a linear orientation or line, which is known as the payline. Original paylines were 3, 4 or 5 frames in a row. After many years, multiple linear paylines (e.g., 1, 2 or 3) were available for wagering in a single game. Typically there was a top line, middle line and bottom line formed by linear arrangements of symbols on reels. A single wager rendered a single line (usually specifically the middle line) active. Two wagers rendered two lines active. Three wagers rendered three lines active.

In the 1990's, with the greater advent of processors and video display screens being used in the construction of gaming apparatus, non-linear paylines were introduced to the gaming industry and specifically into video slot games. These non-linear paylines included symbols at different alignments with symbols taken from different columns and rows in a consecutive arrangement. The paylines included both liner (straight lines) and non-linear paylines (e.g., looking like sawteeth, for example). The use of these non-liner lines increased the number of paylines (and the number of wagers needed to activate all or more of the paylines), with as many as over 100 paylines in a 5×5 column and row display.

Examples of systems using non-linear paylines include, by way of non-limiting examples, U.S. Pat. Nos. 8,012,011; 7,934,990; 7,931,528; 7,918,730 (Trajectory-based 3-D games of chance for video gaming machines); U.S. Pat. Nos. 8,100,751; 7,914,378; 7,874,914, 7,874,904; 7,862,421; 7,862,416; 7,846,018; 7,690,981; 7,666,086; 7,607,980; 7,601,062; 7,601,061; 7,585,221; 7,585,219; 7,578,735; 7,507,156; 7,494,413; 7,393,277; and 7,341,513.

U.S. Pat. No. 6,595,519 (McGoveran) describes a puzzle using Moebius topology and three-dimensional construction to make solution more challenging by preventing the player from seeing all possible layouts at any one time. The preferred embodiment of the puzzle challenges players to solve a maze when part of the maze will always be concealed by the current viewing surface, as the internal and external surface are both contiguous and identical.

RUBIK's cube puzzles are provided as visual bonus awards in U.S. Pat. Nos. 7,004,834; 7,985,132 (Walker), 7,438,642; 7,815,503 (Walker. In various embodiments, an objective in a game, such as a bonus game or secondary game, may be for a puzzle to advance towards completion. Exemplary puzzles are those involving components that can be moved relative to one another. Such puzzles may include a Rubik's cube where, for example, twenty-seven smaller cubes are moved relative to one another. The puzzle reaches completion when each side of the larger cube is monochromatic.); U.S. Pat. No. 8,147,316 (Arezina), FIGS. 22a-22b illustrate exemplary graphics displayed on the display surface 302, 802. Here, the player places the portable device 2102 onto the surface of the display surface 302, 802 in a designated region 2200 and manipulates an angle of a virtual camera to cause a 3-dimensional object 2208 that is related to a wagering game being displayed on the display surface 302, 802. In the example shown the 3-D object 2208 resembles a Rubik's Cube, in which each face of the cube bears wagering-game symbols. Because the Rubik's Cube has six faces, some of which are not visible to the player, the player can manipulate a virtual camera by rotating the physical object 2102 in the designated region 2200 to cause the virtual camera to change its viewing angle. In the example shown, the player has rotated the physical object 2102 by 90 degrees, causing a 90 degree rotation in the camera angle. As a result, symbols that were previously obscured to the player are now visible. The manipulation of the physical object 2102 and the resulting change in camera angle provide the player with a sense of control over the wagering game. The game system 300, 800 can detect the presence of the physical object 2102 when it is placed in the designated region 2200.); U.S. Pat. No. 8,241,100 (Rubik's cube bingo card—In yet another aspect, the multiple separate grids may be simultaneously presented to the player. FIG. 27 shows a graphical depiction of one such implementation. The upper rectangle 270 holds numbers 272a, 272b, 3tc. As shown, there are 5 numbers drawn. The numbers also have an associated color. By way of example, 272a is red, 272b is green, 272c is yellow, 272d is yellow, 272e is blue. The player has multiple cards, such as the six depicted as 276a (red), 276b (blue), 276c (white), 276d (green), 276e (yellow) and 276f (orange). The card 274 associated with the most recent draw 272e is shown in the center. In this case, 272e is blue and the blue card 274 is depicted. Optionally, the multiple grids may be arranged in a geometric pattern. One such geometric pattern is a cube and the multiple grids are arranged on the faces of the cube.); and U.S. Pat. No. 8,322,723 (competitive puzzle game). Published U.S. Patent Application Document No. 20040053683 displays a bonus event comprising a self-reorienting Rubik's cube.

The use of three-dimensional content in display systems has not been fully exploited in video gaming.

### BRIEF DESCRIPTION OF THE FIGURES

FIG. 1 shows a schematic for a Prior Art internet wagering system that may be used in combination with the present invention.

FIG. 1C shows a perspective view of a prior art format for an automated gaming system;

FIG. 2 shows a schematic for a Prior Art internet wagering system that may be used in combination with the present invention;

FIG. 3 shows a schematic for a Prior Art internet wagering system that may be used in combination with the present invention

FIG. 3A shows a side elevational view of a prior art format for an automated gaming system;

FIG. 4 shows a block schematic diagram of the electronic configuration of a prior art automated gaming system;

FIG. 4A shows a schematic for a Prior Art internet wagering system that may be used in combination with the present invention;

FIG. 4B shows a schematic for a Prior Art internet wagering system that may be used in combination with the present invention;

FIG. 5 shows a flow diagram for playing a wagering method according to the present invention;

FIG. 6 shows a schematic diagram of a gaming engine useful in the practice of the present invention;

FIG. 7 shows a schematic diagram of a player station useful in the practice of the present invention; and

FIG. 8 shows a schematic diagram of a game display useful in the practice of the present invention.

FIG. 9 shows a 5×5×5 grid of frames in which and on which symbols may be displayed in accordance with the present technology.

FIG. 9A shows a 3×3×3 grid of frames in which and on which symbols may be displayed in accordance with the present technology.

FIG. 9B shows a 3×3×2 grid of frames in which and on which symbols may be displayed in accordance with the present technology.

FIG. 9C shows a 3×3×2 grid of frames in which and on which symbols may be displayed in accordance with the present technology.

FIG. 9D shows a single volume frame with the center of the volume frame shown.

FIG. 9E shows a 3×3×2 grid of frames in which and on which symbols may define paylines in three dimensions creating larger numbers of frames in the payline than only three frames in accordance with the present technology.

FIG. 9F shows a single volume frame with the center of the volume frame shown.

FIG. 9G shows a 3×3×2 grid of frames in which and on which symbols may define paylines in three dimensions creating larger numbers of frames in the payline than only three frames in accordance with the present technology.

### DETAILED DESCRIPTION OF THE INVENTION

The present technology includes apparatus and a method executed on the apparatus in a wagering environment. One non-limiting example of a of method of playing a wagering game on a gaming system can be described as follows. The apparatus, by way of non-limiting examples may be: a processor, game logic, a video display and player input system. The method may have steps of:
a) the processor accepting a first wager on a game the outcome of which is determined by at least displayed random symbol outcomes in a payline;
b) the processor providing the first random event outcome that comprises at least three individual die outcomes;
c) the processor displaying an image on the video display that includes a virtual image of the displayed random symbol outcomes in a display format that contains symbol display frames in apparent three-dimensions;
d) the processor determining at least whether paylines in apparent three dimensions include virtual symbols forming i) a winning outcome or ii) a non-winning outcome;
e) the processor resolving the first wager by awarding value monitored by the gaming system when i) occurs and withdrawing value monitored by the gaming system when ii) occurs; and
f) the processor determining outcomes on paylines comprising contiguous frames as volumetric stacked frames or overlain two-dimensional frames that virtually extend across three virtual dimensions on the display screen.
   The display of the virtual three dimensions may be effected by perspective two-dimensional view of a three-dimensional array of frames so that all frames are simultaneously viewable. The frames may comprise frames as volumetric stacked frames that virtually extend across three virtual dimensions on the display screen. The frames may be displayed on the display screen as overlain two-dimensional frames that virtually extend across three virtual dimensions on the display screen. The display of the virtual three dimensions may be effected by perspective three-dimensional view of a three-dimensional array of frames so that all frames are simultaneously viewable. The random event outcome may be provided by an electronic random number generator. The at least one winning payline may be contiguous symbols that extend through the virtual three dimensions in a non-linear array.

Another non-limiting example of a method of playing a wagering game on a gaming system is described as:

being played on a processor, game logic, a video display, and player input system, the method having steps of:
a) the processor accepting a first wager on a game the outcome of which is determined by at least displayed random symbol outcomes in a virtual three dimensional payline;
b) the processor displaying an image on the video display that includes a virtual image of the displayed random symbol outcomes in a display format that contains symbol display frames in apparent three-dimensions;
c) the processor determining at least whether paylines in apparent three dimensions include virtual symbols forming i) a winning outcome or ii) a non-winning outcome;
d) the processor resolving the first wager by awarding value monitored by the gaming system when i) occurs and withdrawing value monitored by the gaming system when ii) occurs; and
e) the processor determining outcomes on paylines comprising contiguous frames as overlain grids of two-dimensional frames that virtually extend across three virtual dimensions on the display screen.

Still another non-limiting example of a method of playing a wagering game on a gaming system is described as:

being played on a processor, game logic, a video display, and player input system, the method having steps of:
a) the processor accepting a first wager on a game the outcome of which is determined by at least displayed random symbol outcomes in a payline;
b) the processor providing the first random event outcome that comprises at least three individual die outcomes;
c) the processor displaying an image on the video display that includes a virtual image of the displayed random symbol outcomes in a display format that contains symbol display frames in apparent three-dimensions;
d) the processor determining at least whether paylines in apparent three dimensions include virtual symbols forming i) a winning outcome or ii) a non-winning outcome;
e) the processor resolving the first wager by awarding value monitored by the gaming system when i) occurs and withdrawing value monitored by the gaming system when ii) occurs; and
f) the processor determining outcomes on paylines comprising contiguous frames as volumetric stacked frames or overlain two-dimensional frames that virtually extend across three virtual dimensions on the display screen.

FIG. 1A shows a two-dimensional representation of a three-dimensional array according to the present invention.

FIG. 1B shows the two-dimensional representation of a three-dimensional array according to the present invention as shown in FIG. 1A with a few selected non-linear paylines shown.

All wager resolutions are made by the processor based upon a look-up table in which both all random event outcome and all random symbol placements are considered in the resolution of each wager.

FIG. 2 shows a top plan view of the same prior art automated gaming system 1 with the viewing screen 7 shown more clearly as a CRT monitor. It can also be seen that each player position has to form an arc cut into the semicircular player seating area 18.

FIG. 3 shows a side elevational view of the same prior art automated gaming system of FIGS. 1C and 2 where the orientation of the three different types of CRT monitors 7, 9 and 10 are shown.

FIG. 4 shows the schematic circuitry of a prior art automated system as disclosed in U.S. Patent Publication No. 2003/0199316. FIG. 4 is a block diagram of processing circuitry in the game device of FIG. 1C. The game device housing comprises a CPU block 20 for controlling the whole device, a picture block 21 for controlling the game screen display, a sound block for producing effect sounds and the like, and a subsystem for reading out CD-ROM.

The CPU block 20 comprises an SCU (System Control Unit) 22, a main CPU 24, RAM 26, RAM 28, a sub-CPU 30, and a CPU bus 32. The main CPU 24 contains a math function similar to a DSP (Digital Signal Processing) so that application software can be executed rapidly.

The RAM 26 is used as the work area for the main CPU 24. The RAM 28 stores the initialization program used for the initialization process. The SCU 22 controls the busses 32, 34 and 36 so that data can be exchanged smoothly among the VDPs 38 and 40, the DSP 42, and other components.

The SCU 22 contains a DMA controller, allowing data (polygon data) for character(s) in the game to be transferred to the VRAM in the video picture block 21. This allows the game machine or other application software to be executed rapidly. The sub-CPU 30 is termed an SMPC (System Manager & Peripheral Control). Its functions include collecting sound recognition signals from the sound recognition circuit 44 or image recognition signals from the image recognition circuit 46 in response to requests from the main CPU 24. On the basis of sound recognition signals or image recognition signals provided by the sub-CPU 30, the main CPU 24 controls changes in the expression of the character(s) appearing on the game screen, or performs image control pertaining to game development, for example. The picture video block 21 comprises a first VPD (Video Display Processor) 38 for rendering TV game polygon data characters and polygon screens overlaid on the background image, and a second VDP 40 for rendering scrolling background screens, performing image synthesis of polygon image data and scrolling image data based on priority (image priority order), performing clipping, and the like. The first VPD 38 houses a system register 48, and is connected to the VRAM (DRAM) 52 and to two frame buffers 54 and 56. Data for rendering the polygons used to represent TV game characters and the like is sent to the first VPD 38 through the main CPU 24, and the rendering data written to the VRAM 52 is rendered in the form of 16- or 8-bit pixels to the rendering frame buffer 54 (or 56). The data in the rendered frame buffer 54 (or 56) is sent to the second VDP 40 during the display mode. In this way, buffers 54 and 56 are used as frame buffers, providing a double buffer design for switching between rendering and display for each individual frame. Regarding information for controlling rendering, the first VPD 38 controls rendering and display in accordance with the instructions established in the system register 48 of the first VPD 38 by the main CPU 24 via the SCU 22.

The second VDP 40 houses a register 50 and color RAM 58, and is connected to the VRAM 60. The second VDP 40 is connected via the bus 36 to the first VPD 38 and the SCU 22 and is connected to picture output terminals Voa through Vog through memories 62a-d and encoders 64a-d. The picture output terminals Voa through Vog are connected through cables to the main game displays 66, 68 and the satellite displays 70. Scrolling screen data for the second VDP 40 is defined in the VRAM 60 and the color RAM 58 by the CPU 24 through the SCU 22. Information for controlling image display is similarly defined in the second VDP 40. Data defined in the VRAM 60 is read out in accordance with the contents established in the register 50 by the second VDP 40, and serves as image data for the scrolling screens that portray the background for the character(s). Image data for each scrolling screen and image data of texture-mapped polygon data sent from the first VPD 38 is assigned display priority (priority) in accordance with the settings in the register 48, and the final image screen data is synthesized.

Where the display image data is in palette format, the second VDP 40 reads out the color data defined in the color RAM 58 in accordance with the values thereof, and produces the display color data. Color data is produced for each display 66 and 68 and for each satellite display 70. Where display image data is in RGB format, the display image data is used as-is as display color data. The display color data is temporarily stored in memories 62a-d and is then output to the encoders 64a-d. The encoders 64a-d produce picture signals by adding synchronizing signals to the image data, which is then sent via the picture output terminals Voa through Vog to the display 66, 68 and the satellite displays 70. In this way, the images required to conduct an interactive game are displayed on the screens of the display 66, 68 and the satellite displays 70.

The sound block 72 comprises a DSP 42 for performing sound synthesis using PCM format or FM format, and a CPU 74 for controlling the DSP 42. Sound data generated by the DSP 42 is converted into 2-channel sound signals by a D/A converter 76 and is then presented to audio output terminals Ao via an interface (not shown). These audio output terminals Ao are connected to the input terminals of an audio amplification circuit (not shown). Thus, the sound signals presented to the audio output terminals Ao are input to the audio amplification circuit (not shown). Sound signals amplified by the audio amplification circuit drive the speakers 16a and 16b.

The subsystem 78 comprises a CD-ROM drive 80, a CD-I/F 82, and CPU 84, an MPEG-AUDIO section 86, and an MPEG-PICTURE section 88. The subsystem 78 has the function of reading application software provided in the form of a CD-ROM and reproducing the animation. The CD-ROM drive 80 reads out data from CD-ROM. The CPU 84 controls the CD-ROM drive 80 and performs error correction on the data read out by it. Data read from the CD-ROM is sent via the CD-I/F 82, bus 34, and SCU 22 to the main CPU 24 that uses it as the application software. The MPEG-AUDIO section 86 and the MPEG-VIDEO section 88 are used to expand data that has been compressed in MPEG (Motion Picture Expert Group) format. By using the MPEG-AUDIO section 86 and the MPEG-VIDEO section 88 to expand data that has been compressed in MPEG format, it is possible to reproduce motion picture. It should be noted herein that there are distinct processors for the CPU block, video block, sound block, CD-ROM drive and Memory with their independent CPU's. This requires significant computing power and still has dumb (no intelligence) player input components.

FIG. 5 shows a flow chart of one method of electronic play of a game of the preent invention.

FIG. 6 shows an electronic/processor schematic for a MultiPlayer Platform (MPP) gaming system according to the presently described invention. The MPP Game engine (dealer) comprises a Heber Pluto 5 casino game board 120 (Motorola 68340 board) operating off the PC Platform Pentium® 4 MPP Game Display processor 122. The game display processor operates on a Windows XP platform. The respective subcomponents on the Pentium 4 processor are labeled to show the apportionment of activity on the motherboard and the component parts added to the board. As is shown, the game engine has an Uninterruptible Power Supply 124. The game display processor directs activity on the Speakers, directs activities onto the MPP Game Service panel, and the Plasma Monitor Card Table display. It is important to note that all communications are direct from the game display processor, freeing up resources available to the game engine processor.

FIG. 7 shows the electronic/processing schematics 126 of the MPP Player Station Intelligence board 128 (Heber Pluto 5 Casino, Motorola 68340), each of which player stations (one for each player position) is in direct connection to the MPP Game Engine 130 (Dealer), which is in turn directly connected to the PC Platform (not shown in this Figure). Each Intelligence board receives information for all player input systems 132a-f specific to that player station, such as the shown Coin Acceptor, Coin Hopper, Bill validator, Ticket Printer, Touch Screen and/or Display Button Panel, Dual Wire Ticket-in-Ticket-Out Printing and SAS System (SAS is one exemplary standard communications protocol used by a number of casinos central computer systems.) A significant benefit resides in the use of the independent Intelligent boards 128 at each player position being in direct communication with the MPP Game Engine 130, as opposed to each individual player position button panel being dead or inactive until authorized by the main game processor, as previous automated gaming systems were constructed.

The above-described architecture is also an improvement in providing a system with not only the intelligence at each player position, but also in redistributing processing capability for functions among various processing components within the gaming system. In one architectural format, all functions of the gaming engine, except for the player localized intelligence functions, are consolidated into a single PC (e.g., the Pentium 4 shown in the Figures). This would include all game functions, player video functions, dealer video functions, dealer audio functions, security, central reporting (to a casino's central computer, for example), currency and debit functions, alarm functions, lighting functions, and all other peripherals on the system, except for the localized player functions. Alternatively, all functions requiring communication with the casino's main computer system are located on the player station intelligent boards. In this system, the main game processor would talk directly with the player intelligent boards, preferably in the same novel communication format described below.

An alternative system is shown in FIG. 8, where there is a dealer engine processor 132 intermediate the main game PC 134 and the Player intelligent boards (not shown). Both systems are a distinct improvement over the prior art, but with the higher power available for PC's, and with the ease of programming a PC as opposed to an embedded system, the consolidation of the game functions and the ability of the main game engine to communicate with each of the player positions is enabled. As shown in FIG. 8, the Game display processor 134 is preferably a Pentium® 4 PC and is separate from the main processor 132. With the player intelligent boards, the main game PC can receive packets of information from each player station as events occur rather than having to poll each player position on a regular basis 100 times to gain the specific information for each player input that may be made.

A description of the Heber Board, (an exemplary board that can be used as a player station processor and/or game engine processor 132) a commercially available intelligent processing board is as follows. The Heber Board is known for its reliability and flexibility, especially for the Pluto 5 family of gaming products. The Pluto 5 is the controller of choice for the global gaming industry. Flexibility comes from a set of features built into the Pluto 5 (Casino) controller, and from the choice of optional add-on boards that can be used to adapt the Pluto family to best suit individual applications. In the area of interfacing, there are three distinct boards, each of which serves a particular function in helping the Pluto 5 to connect with the world outside.

### RS485 Board

RS485 is an industrial-grade board for linking multiple systems in unforgiving circumstances for centralized information gathering. The Heber RS485 board is fully optically-isolated to provide complete circuit safety when used within ‘electrically noisy’ environments. The RS485 board uses a single RS232 connection to the Pluto 5 board and all necessary power is also derived through this link. Two header connectors may be provided for the RS485 channel to allow daisy chain connections between multiple systems.

### HII/ccTalk Board

This board specializes in communicating with industry standard note/coin acceptors and payout hoppers. Equipped with dual communication channels, each port is configurable to use either the HII format to connect with Mars® coin/note acceptors or the ccTalk format for Money Controls® hoppers. Both channels are controlled via a single RS232 connection to the Pluto 5 board and all necessary power is also derived through this link. The Heber FastTrack™ package contains modular library functions for passing information via these channels.

### Four Channel Relay Board

The relay board allows control of medium- to high-level loads such as solenoids, without risk of damage or interference to the Pluto 5 circuitry. Four power-switching channels are available with absolute isolation from the Pluto 5 control signals. Each relay is capable of switching direct or alternating currents of up to 7 A at a maximum voltage of 250V.

Like the Pluto 5 board itself, its modular options have been used extensively so that their designs are fully developed and entirely stable. The options that are specified are consistently provided in mass quantities. As with all Pluto products, programming for the modular options is straightforward. This is enhanced with the use of the Pluto 5 Enhanced Development Kit and also the FastTrack™ package. Between them, these kits contain all of the low level and high level programming tools and library functions needed for gaming applications. These systems can be provided through a Pluto 5 Enhanced Development Kit datasheet 80-15353-7 (Heber Limited, Belvedere Mill, Chalford, Stroud, Gloucestershire, GL6 8NT, UK Tel: +44 (0) 1453 886000 Fax: +44 (0) 1453 885013; www.heber.co.uk). Specifications for the various boards are identified below.

### RS485 Interface

Host Interface

RS232 connection to Pluto 5/Pluto 5 Casino All power provided via RS232 link from host system Communication Port Dual four-way Molex 0.1″ KK headers for daisy chaining purposes Dimensions 80.times.61 mm (3.14×2.4″) Part Number Opto-isolated RS485 board 01-14536-2 HII/ccTalk Interface Host Interface RS232 connection to Pluto 5/Pluto 5 Casino All power provided via RS232 link from host system Communication Port Single or dual 10 way header connectors Dimensions 101.6.times.69.85 mm (4.times.2.8″) Part Number Dual channel HII/ccTalk board 01-16171-2 Four Channel Relay Board Host Interface Connection to Pluto 5/Pluto 5 Casino via ribbon cable using four standard output lines All power provided via ribbon cable link from host system Switching Capabilities Up to 250V AC or DC@7 A maximum per channel Dimensions 80.times.61 mm (3.14.times.2.4″) Part Number Four channel relay board 01-15275-1 80-16949-1

One proposed hardware configuration uses a “satellite” intelligent processor at each player position. The player station satellite processor is substantially the same as the primary game engine processor, a Heber Pluto 5 Casino board. The satellite processors receive instruction from the primary game engine but then handle the communications with player station peripherals independently. Each satellite processor communicates with only the peripherals at the same player station. Thus each player station has a dedicated satellite processor communicating with only the peripherals at the same player station and with the casino's central computer system. The peripherals are, but not limited to: Slot accounting Systems, Bill Validator, Ticket Printer, Coin Acceptor, Coin Hopper, Meters, Button panel or LCD touch screen and various doors and keys.

The satellite processors run proprietary software to enable functionality. The player station software is comprised of two modules, the first being an OS similar to the game engine Operating System and the second being station software that handles peripheral communications. The software may be installed on EPROMs for each satellite processor. The primary method of communication between the satellite processors and the primary game engine is via serial connectivity and the previously described protocol. In one example, information packets are prepared by the satellite processors and are sent to the game engine processor on the happening of an event.

The proposed game engine provides communication to the player stations to set the game state, activate buttons and receive button and meter information for each player station. Communication is via a serial connection to each of the stations. The new protocol for communication between the game engine, game display and player stations is an event driven packet-for-packet bi-directional protocol with Cyclic Redundancy Check (CRC) verification. This is distinguished from the Sega system that used continuous polling. This communication method frees up resources in the same engine processor because the processor no longer needs to poll the satellites continuously or periodically.

The new protocol uses embedded acknowledgement and sequence checking. The packet-for-packet protocol uses a Command Packet, Response Packet and a Synchronization Packet as illustrated below. The protocol uses standard ASCII characters to send data and a proprietary verification method.

FIG. 9 shows a 5×5×5 grid of frames in which and on which symbols may be displayed in accordance with the present technology. The grid and frames are identified by columns A B C D and E, rows i ii iii iv and v, and depth as a b c d and e. A single frame would therefore be identified by at least the three frame coordinates and also by the position on the surface of the cube defined by the frame coordinates. For example, the cubic grid frame in the back, right, upper corner would be F, i, a, and would have up to 6 outer frame positions and one central frame position available as display positions for symbols. This will be shown more clearly in later Figures.

FIG. 9 A shows a 3×3×3 grid of frames in which and on which symbols may be displayed in accordance with the present technology. Six surface cube positions for appearance of random symbols are shown as ° positions on the outer faces of cubic frames A, ii, c and B, ii, c and C, ii, c and A, ii, a and B, ii, a and C, ii, a.

FIG. 9 B shows a 3×3×2 grid of frames in which and on which symbols may be displayed in accordance with the present technology. The square position indicators are indicators of side frame positions on which symbols may be positioned for paylines.

FIG. 9 C shows a 3×3×2 grid of frames in which and on which symbols may be displayed in accordance with the present technology at Δ positions on the cubic frames. The Δ positions are centered within each cube that can be used as paylines.

FIG. 9D shows a single volume frame with the center of the volume frame shown.

FIG. 9 E shows a 3×3×2 grid of frames in which and on which symbols may define paylines in three dimensions creating larger numbers of frames in the payline than only three frames in accordance with the present technology. The arrows show progression along paylines. Consecutive symbol locators (Δ) are in consecutive cubic volumes along three dimensions. Note that Δ 9a is located in depth b while all other symbols positions Δ are in consecutive cubic volumes within depth a. Also shown are the outer face positions (° positions) on the outer faces of cubic frames. These ° positions may be (by control of the game design and software) be used exclusively with other ° positions or may be combined with side face position (the squares) and/or the central cubic positions (Δ). By using some or all of these 7 available positions on each cubic frame, an extremely high potential for numbers of paylines is created in three dimensions.

FIG. 9F shows a single volume frame with the center of the volume frame shown. Paylines may even be within the single cubic frame as well as extending between other cubic frames. These internal cubic frame paylines can also effectively be in three dimensions or linear.

FIG. 9G shows a 3×3×2 grid of frames in which and on which symbols may define paylines in three dimensions creating larger numbers of frames in the payline than only three frames in accordance with the present technology. Note again the variations available in three dimensions, even with only center position (Δ) symbol positions available.

It is to be further noted that faces of adjacent cubic frames can be considered as identical, that is (looking at FIG. 9B, the center square (right) in A, ii, a is also (potentially) the center square (left) in B, ii, a. This offers the p[ossible of a designated payline, including either or both of center square (right) in A, ii, a and (potentially) the center square (left) in B, ii, a. As a processor can handle the random symbol distribution as well as the data analysis in real time, even additional paylines can be configured from the cubic grid array described herein. Additionally, alternative symbols may be positioned or overlain at center square (right) in A, ii, a and (potentially) the center square (left) in B, ii, a. The symbols may be larger, different color and/or active/inactive in one overlain center position than in the other to assist in visual distinction between the symbols.

When selecting paylines, prior to actual activation of the game (e.g., hitting SPIN or PLAY button or icon), it is possible, if not desirable to highlight all paylines being wagered upon. This facilitates a visual impression of the number of lines being wagered upon. Density or color of these pre-game payline indicator lines can distinguish among different sizes of the wagers. This is distinctly different from the display of only winning outcomes in paylines at the conclusion of the game play.

### Technical Description and Benefits of Electronic 3-D Gaming

If the player touches any particular betting position, the video display (touch screen) and processor will appear in larger format and display the current roll of the dice result and show his wager selections.

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In some embodiments, a server computer and one or more client computers may perform desired actions. Actions may be performed by one or more of the clients and/or servers in accordance with a desired distribution of labor. Such distribution of labor may be made based on where the actions may be performed more securely, more quickly, and/or more cost-effectively. For example, in some implementations, complex calculations may be performed by a central server to increase speed, display related calculations may be performed by a client because they may be simple, outcome determining calculations may be performed by a central server in order to ensure the validity of the calculations and allow tweaking of odds to be performed at a single location. It should be recognized that any desired actions may be divided among a server and any number of clients in any desired way.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human). In one embodiment, the gaming device preferably includes at least one processor, such as a microprocessor, a microcontroller-based platform, a suitable integrated circuit or one or more application-specific integrated circuits (ASIC's). The processor is in communication with or operable to access or to exchange signals with at least one data storage or memory device. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information and applicable game rules that relate to the play of the gaming device. In one embodiment, the memory device includes random access memory (RAM), which can include non-volatile RAM (NVRAM), magnetic RAM (MRAM), ferroelectric RAM (FeRAM) and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD or USB memory device. In other embodiments, part or all of the program code and/or operating data described above can be downloaded to the memory device through a suitable network.

In one embodiment, an operator or a player can use such a removable memory device in a desktop computer, a laptop personal computer, a personal digital assistant (PDA), portable computing device, or other computerized platform to implement the present disclosure. In one embodiment, the gaming device or gaming machine disclosed herein is operable over a wireless network, such as part of a wireless gaming system. In this embodiment, the gaming machine may be a hand held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In one embodiment, as illustrated in FIG. 2A, the gaming device includes one or more display devices controlled by the processor. The display devices are preferably connected to or mounted to the cabinet of the gaming device. The embodiment shown in FIG. 1A includes a central display device 16 which displays a primary game. This display device may also display any suitable secondary game associated with the primary game as well as information relating to the primary or secondary game. The upper display device may display the primary game, any suitable secondary game associated or not associated with the primary game and/or information relating to the primary or secondary game. These display devices may also serve as digital glass operable to advertise games or other aspects of the gaming establishment. As seen in FIG. 1A, in one embodiment, the gaming device includes a credit display 20 which displays a player's current number of credits, cash, account balance or the equivalent. In one embodiment, the gaming device includes a bet display 22 which displays a player's amount wagered. In one embodiment, as described in more detail below, the gaming device includes a player tracking display 40 which displays information regarding a player's playing tracking status.

In another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LED), a display based on a plurality of organic light-emitting diodes (OLEDs), a display based on polymer light-emitting diodes (PLEDs), a display based on a plurality of surface-conduction electron-emitters (SEDs), a display including a projected and/or reflected image or any other suitable electronic device or display mechanism. In one embodiment, the display device includes a touch-screen with an associated touch-screen controller. The display devices may be of any suitable size and configuration, such as a square, a rectangle or an elongated rectangle.

The general scope of the invention may include methods and systems as follows. A method of playing a wagering game on an electronic gaming system may have, for example:
a) a central processor;
b) a video display system;
c) data entry systems in communication with the central processor;
d) an electronic random number generator in communication with the central processor; and
e) memory containing look-up tables of event result tables;

The proposition wagers, if any, are recognized by the processor from the data entry system, the proposition wager being on at least one proposition wager event determined by the virtual image results.

The event outcome is determined by the processor executing code to compare the virtual gaming event outcome from the image displays and the event results table. The proposition wagers may be recognized as being on at least one proposition wager event determined by the display of images selected from the group consisting of the side bet wagers or other events. The processor displays at least one of the event result tables on the video display system and indicates virtual game outcomes for the results, and in the variant with two or more colors, the possible event outcomes on wagers using non-selected colors may also be displayed. The processor compares and may cause to be displayed the random event of the virtual casting of the three virtual dice with the event result tables or paytables to determine wagering or game events from the random event. The data entry systems are selected from the group consisting of hand-held wireless communication devices, networked television systems, keypads, stand-alone wagering terminals, personal computers on a network or internet and banks of wagering terminals.

A gaming system for playing the wagering game may have, as described in greater detail above:
a) a central processor;
b) a video display system;
c) data entry systems in communication with the central processor;
d) an electronic random number generator in communication with the central processor; and
e) memory containing look-up tables of event result tables.

The present gaming technology may also be practiced with variations of technology available internet gaming. Apparatus and methods described in Published U.S. Patent Application Documents Nos. 20120089921; 20110082571; 20100234110; 20090036186; 20080201227; 20080033734; 20070162563; 20040249707; 20040067794; 20030224856; 20030032480; 20020082085, which are incorporated herein in their entirety to support and enable internet wagering on the present invention.

FIG. 1 is a diagram that illustrates an Internet gaming system according to the invention in general. The system according to the invention comprises at least one server (e.g., servers 101, 102 . . . ) and at least one computer (e.g., computers 111, 112 . . . ) connected to the at least one server over the Internet, e.g., using an Internet service provider such as America Online™ (AOL™) or Prodigy™. An Internet service provider or ISP is a service, commercial or otherwise, that provides access to the Internet for end users. The servers 101, 102 . . . are connected to the Internet via connections (e.g., connections 121, 122 . . . ) respectively) such as a modem line, a T1 line or any variant of digital subscriber line (DSL) including ADSL (advanced digital subscriber line). The computers 111, 112 . . . are connected to the Internet via connections (e.g., connections 131, 132 . . . , respectively) such as a modem line, a T1 line or any variant of digital subscriber line (DSL) including ADSL (advanced digital subscriber line). Purchasers of wagers or entry into the gaming system, as end users at one of the computers can access a server over the Internet using the service provided by the ISP.

The servers (101, 102 . . . ) can send information to the purchasers of lottery tickets by communicating with the computers (111, 112 . . . ) over the Internet (e.g., via connections 121, 122 . . . and 131, 132 . . . , respectively), the at least one telephone (e.g., tel 143, 144 . . . ) over landline 134, the at least one fax (e.g., fax 145, 146 . . . ) over landline 135, or the at least one cellular telephone (e.g., 147, 148 . . . ) over the airwaves or via satellite by using transmitter 141 provided therefor. If a group of players desires to place wagers in bulk, a virtual group may be created therefor at a server which includes corresponding information with respect to the group of purchasers (group information) and the placing of wagers.

Systems used may also operate as a system in which the remote gaming system provides remote access to a legal gaming system. In one example, the participant may be located at a distant city, The player may be accessing the game using his personal communication system, tablet, Pad, processor, PC etc. The participant will access a game server at a remote location. The game server may be on an Indian reservation, wherein gaming is authorized and legal. The game system will include a database which will include critical information of the participant, assuring that he is authorized to operate the game. For example, the participant will provide critical personal information such as personal ID and the location of the terminal or, as shown, the user communication system or terminal (e.g., PC).

The location of the terminal is a critical component of the invention. In most jurisdictions where gaming is legal, it is not legal to cross state lines. So in almost all cases, even where remote access is permitted, the game operator and the participant must be in the same state. Therefore, the game operator must have assurances that the accessing terminal is in the same state as the game server or over federally authorized gaming services and/or providers.

When a terminal is permanently installed, the location is known. When a portable device is used, such as a PDA, cell phone, laptop or the like, the position is not known unless a positioning signal is sent to the game server. In those instances where a portable terminal is used, or even where a permanently installed terminal may be routinely moved, the terminal may be required to have a GPS signal generator which can be received by the game server to assure the location of the participant.

The GPS signal generator would he associated with any device which has the capability of being moved to a new location which may be outside the authorized jurisdiction, for example, a PDA, a cell phone, as well as the user PC. The GPS signal generator may not be required in a permanently installed kiosk.

In use of any of the terminals, the participant accesses the game server via the Internet. The critical m information for the participant is maintained in the database. This confirms that the participant is an authorized participant and that he is in an authorized location.

In one embodiment of the invention a biometric sensor will be associated with each remote terminal which can be used by the participant to access the game sever. This provides even more detailed information assuring authenticity of the participant.

Typically, the server will request the biometric information at the outset of a session and for each transaction, or at the minimum, on a random basis. It may be desirable to shut down the terminal for a specified period of time (lock it out from the game server) in the event an unauthorized participant is detected. The game operator may have a banking capability at the authorized gaming location. In this case, the bank server would have the capability to transact electronic banking functions with the game server without violating any wire or banking laws and regulations. The participant may have an account at the bank associated with server. He will place funds in this account. When he participates in gaming from a remote location, he will have preauthorized the game sever to electronically withdraw or deposit funds into his account via the banking sever. The participant is not involved in these transactions. He may access his account via the banking server in normal fashion and may deposit or withdraw funds. However, the participant cannot communicate with the game server about financial transactions. For example, in the event the participant becomes overdrawn, the resolution of that is between him and the bank. The game operator is not involved.

The present technology may also be used in combination with hologram technology which is the subject matter of U.S. patent application Ser. No. 13/631,195 filed 28 Sep. 2012, which is incorporated herein by reference. Any format, system or apparatus that can be used to provide the processor, video display system, player input system, game rules, communication links and memory can be modified by one skilled in the art and adapted top play of the present technology.

What is claimed:

1. A method of playing a wagering game on a gaming system that comprises a processor, game logic, a video display and player input system, the method comprising:
a) the processor accepting a first wager on a game the outcome of which is determined by at least displayed random symbol outcomes in a payline;
b) the processor providing the first random event outcome that comprises at least three individual die outcomes;
c) the processor displaying an image on the video display that includes a virtual image of the displayed random symbol outcomes in a display format that contains symbol display frames in apparent three-dimensions;
d) the processor determining at least whether paylines in apparent three dimensions include virtual symbols forming i) a winning outcome or ii) a non-winning outcome;
e) the processor resolving the first wager by awarding value monitored by the gaming system when i) occurs and withdrawing value monitored by the gaming system when ii) occurs; and
f) the processor determining outcomes on paylines comprising contiguous frames as volumetric stacked frames or overlain two-dimensional frames that virtually extend across three virtual dimensions on the display screen.

2. The method of claim 1 wherein display of the virtual three dimensions is effected by perspective two-dimensional view of a three-dimensional array of frames so that all frames are simultaneously viewable.

3. The method of claim 1 wherein the frames comprise frames as volumetric stacked frames that virtually extend across three virtual dimensions on the display screen.

4. The method of claim 1 wherein the frames are displayed on the display screen as overlain two-dimensional frames that virtually extend across three virtual dimensions on the display screen.

5. The method of claim 1 wherein display of the virtual three dimensions is effected by perspective three-dimensional view of a three-dimensional array of frames so that all frames are simultaneously viewable.

6. The method of claim 1 wherein the random event outcome is provided by an electronic random number generator.

7. The method of claim 2 wherein the first random event outcome is provided by an electronic random number generator.

8. The method of claim 1 wherein at least one winning payline comprises contiguous symbols that extend through the virtual three dimensions in a non-linear array.

9. The method of claim 1 wherein at least one winning payline in i) comprises contiguous symbols that extend through the virtual three dimensions in a non-linear array.

10. The method of claim 2 wherein at least one winning payline in i) comprises contiguous symbols that extend through the virtual three dimensions in a non-linear array.

11. The method of claim 7 wherein at least one winning payline in i) comprises contiguous symbols that extend through the virtual three dimensions in a non-linear array.

12. The method of claim 3 wherein at least one winning payline in i) comprises contiguous symbols that extend through the virtual three dimensions in a non-linear array.

13. The method of claim 12 wherein the first random event outcome is provided by an electronic random number generator.

14. A method of playing a wagering game on a gaming system that comprises a processor, game logic, a video display, and player input system, the method comprising:
a) the processor accepting a first wager on a game the outcome of which is determined by at least displayed random symbol outcomes in a virtual three dimensional payline;
b) the processor displaying an image on the video display that includes a virtual image of the displayed random symbol outcomes in a display format that contains symbol display frames in apparent three-dimensions;
c) the processor determining at least whether paylines in apparent three dimensions include virtual symbols forming i) a winning outcome or ii) a non-winning outcome;
d) the processor resolving the first wager by awarding value monitored by the gaming system when i) occurs and withdrawing value monitored by the gaming system when ii) occurs; and
e) the processor determining outcomes on paylines comprising contiguous frames as overlain grids of two-dimensional frames that virtually extend across three virtual dimensions on the display screen.

15. The method of claim 14 wherein display of the virtual three dimensions is effected by perspective two-dimensional view of a three-dimensional array of frames so that all frames are simultaneously viewable.

16. The method of claim 14 wherein the random event outcome is provided by an electronic random number generator.

17. The method of claim 15 wherein at least one winning payline comprises contiguous symbols that extend through the virtual three dimensions in a non-linear array.

18. The method of claim 15 wherein at least one winning payline in i) comprises contiguous symbols that extend through the virtual three dimensions in a non-linear array.

19. The method of claim 14 wherein at least one winning payline in i) comprises contiguous symbols that extend through the virtual three dimensions in a non-linear array.

20. The method of claim 15 wherein at least one winning payline in i) comprises contiguous symbols that extend through the virtual three dimensions in a non-linear array.

21. The method of claim 16 wherein at least one winning payline in i) comprises contiguous symbols that extend through the virtual three dimensions in a non-linear array.

22. A gaming apparatus comprising a processor, game logic, a video display and player input system, the processor and game logic configured to execute a method comprising:
a) the processor accepting a first wager on a game the outcome of which is determined by at least displayed random symbol outcomes in a payline;
b) the processor providing the first random event outcome that comprises at least three individual die outcomes;
c) the processor displaying an image on the video display that includes a virtual image of the displayed random symbol outcomes in a display format that contains symbol display frames in apparent three-dimensions;
d) the processor determining at least whether paylines in apparent three dimensions include virtual symbols forming i) a winning outcome or ii) a non-winning outcome; and
e) the processor resolving the first wager by awarding value monitored by the gaming system when i) occurs and withdrawing value monitored by the gaming system when ii) occurs.
